(19) United States
(12) Patent Application Publication
(10) Pub. No.: US 2016/0064758 A1
(43) Pub. Date: Mar. 3, 2016

(54) Microbial Fuel Cell for Generating Electricity, and Process for Producing Feedstock Chemicals Therefor

(71) Applicant: UNIVERSITY OF WINDSOR, Windsor (CA)

(72) Inventors: Jerald A. Lalman, Windsor (CA); Wudneh Ayele Shewa, Windsor (CA)

(21) Appl. No.: 14/824,248

(22) Filed: Aug. 12, 2015

Related U.S. Application Data
(60) Provisional application No. 62/043,848, filed on Aug. 29, 2014.

(51) Int. Cl. H01M 8/06; B01J 21/06; H01M 8/16; B01J 23/10; B01J 27/04; B01J 19/12; B01J 35/00; B01J 23/06

(52) U.S. Cl. CPC H01M 8/06; B01J 35/004; B01J 21/063; B01J 23/06; B01J 23/10; B01J 27/04; B01J 19/123; H01M 8/16

(57) ABSTRACT

A method of preparing feedstock chemical for use in a microbial fuel cell comprises admixing a sodium lignosulfate solution with a catalyst to form a chemical slurry, irradiating the slurry with ultraviolet electromagnetic energy to effect photocatalytic degradation of the sodium lignosulfate lower weight molecular compounds selected from the group consisting of methanol, formic acid, acetic acid C-2 alcohols and C-4 alcohols as part of a photocatalyzed mixture, and separating said catalyst from said photocatalyzed mixture to form a feedstock concentrate.

### RELATED APPLICATIONS

This application claims priority and the benefit of 35 U.S.C §119(e) from U.S. Provisional Patent Application Ser. No. 62/043,848, filed 29 Aug. 2014, the disclosure of which is incorporated herein by reference in its entirely.

### SCOPE OF THE INVENTION

The present invention relates to a process for the photocatalysis of lignin, and more particularly the production of feedstock chemicals by lignin photocatalysis for use in microbial fuel cells for electricity generation.

### BACKGROUND OF THE INVENTION

Lignin (from the Latin word lignum, wood) is a highly branched polymer of phenylpropanoid compounds, and a component of plant cell walls. After cellulose, lignin is the second most abundant organic compound in plants, representing approximately 30% of the organic carbon in the biosphere. The use of lignin is becoming more attractive is a variety of applications as it is not dependent on the supply and cost of fossil fuel resources; its supply increases in pulp production; and lignin is readily available in large quantities.

Approximately 30 million tons of lignin is produced annually from wood pulping. This complex cross-linked polymeric structure of phenolic monomers is impermeable and resistant to enzymatic cleavage. The recalcitrant chemical structure and stability of lignin makes biological degradation difficult. As a result, the treatment of wastewaters from paper and pulp industries and other facilities that generate lignin-rich effluents has heretofore proven challenging.

### SUMMARY OF THE INVENTION

The applicant has appreciated that lignin may advantageously be used a starting material in the production of types of feedstock chemicals which may be used in fuel cells for the production of the electricity. In particular, advantageously, lignin is an abundant renewal chemical having complex recalcitrant structure which is difficult to degrade using biological methods. The applicant has appreciated that certain selected catalysts, such as various metal oxides and/or sulfides, may advantageously be used as part of a commercial process to degrade lignin into fuel cell feedstocks, as well as other component compounds which have the potential for use in a variety of different industrial applications.

It is recognized that from a commercial perspective, using pure cultures in microbial fuel cells is impractical, primarily because of contamination from microorganisms in feedstocks. An alternative approach is to use mixed cultures from municipal treatment facilitates, soil and composting sources as they may contain significant levels of electrogenic bacteria. Mixed culture systems have been shown to achieve higher power densities in comparison to pure cultures in many circumstances. Studies conducted by comparing pure culture and mixed culture inoculated microbial fuel cells, suggest that the pure culture exoelectrogens may produce a current significantly lower than (jess than 10%) that of a mixed culture inoculated microbial fuel cell. The applicant has appreciated that microbial fuel ceils (MFCs) may advantageously be used in a number of applications, including the treatment of municipal or industrial wastewater which has been inoculated or which contains a lignin source material using a combined treatment process used to generate a chemical feedstock.

In one preferred embodiment, electricity production from a microbial fuel cell is achieved using a solution comprising or otherwise inoculated with a lignin model compound. The system is effected using a multi-step process which includes producing a chemical feedstock by the photocatalysis of a lignin source material, followed by the feedstock bio-electrochemical conversion in the microbial fuel cell (MFC).

More preferably, lignin source materials such as sodium lignosulfonate (LS) produced as a byproduct in the production of typically wood pulp, is selected as the model lignin compound LS may be provided in a source solution such as a waste water at initial concentrations of 200 to 1000 mg/L, and preferably about 500 mg L⁻¹ (683 mg COD L⁻¹). In the photocatalytic degradation process, a metal oxide or sulfide, and preferably titanium dioxide (TiO₂) is used as a catalyst to covert model lignin chemical into short chain carbon chemicals in the presence of electromagnetic radiation, and most preferably ultraviolet light.

In one possible application, effluent feedstock from the photocatalytic degradation process was fed in either a batch or continuous feed manner into microbial fuel cell. Most preferably the MFC is chosen as a single chamber air-cathode microbial fuel cell (SC-MFC) to generate electricity. The SC-MFCs operate at between about 15° and 40° C. and preferably operating at about 21° C., generating a maximum current and power densities of 3925±280 mA m⁻³ and 1164±208 mW m⁻³, respectively. More preferably, a corresponding maximum current and power densities normalized to cathode area were 166±30 mA m⁻² and 560±40 mW m⁻², respectively. The two step process preferably is operable to remove at least 60% and preferably about 86% of the initial chemical oxygen demand (COD) in the LS. It has been recognized that combining photocatalysis together with a bio-electrochemical process may, thus, prove useful for degrading a model lignin chemical.

TiO₂ shows promise as a preferred catalyst for the photocatalytic degradation of lignin and lignin compounds. Other types of metal oxides such as ZnO, ZrO₂, CeO₂ and/or metal sulfides such as CdS and ZS, or combinations thereof may also be used as catalysts used in photodegradation of various lignin compounds.

Titanium dioxide (TiO₂) is preferentially used because of its ability to completely degrade a wide array of organic compounds to CO₂ plus H₂O. In addition to simple carbon chemicals. TiO₂ has been found effective to almost completely degrade lignin in the presence of ultraviolet light. Other reasons for selecting TiO₂ is related to stability under various conditions, its ease of availability and a relatively low price. Titanium dioxide exists primarily as anatase, rutile and brookite. The anatase phase is used preferably because it is generally catalytically more active in comparison to the rutile and brookite phases.

Accordingly, in one aspect the present invention resides in a method of preparing feedstock chemical for use in a microbial fuel cell comprising, admixing a source mixture comprising a lignin source material with a catalyst to form a chemical source slurry, irradiating said source slurry with electromagnetic energy at a wavelength selected to effect photocatalytic degradation of said lignin source material to short chain fatty acid and/or carbon chemicals as part of a photocatalyzed mixture, separating said catalyst from said photocatalyzed mixture, separating from one or more residual fatty acids from the photocatalyzed mixture to form a concentrate, and feeding said concentrate to said microbial fuel cell.

In another aspect, the present invention resides in a method of preparing feedstock chemical for use in a microbial fuel cell comprising, admixing a source mixture comprising sodium lignosulfate as a lignin source material with a metal oxide and/or metal sulphide catalyst to form a chemical source slurry, irradiating said source slurry with electromagnetic energy at a wavelength selected at between about 100 nm and 400 nm for a period of time selected to effect photocatalytic degradation of said lignin source material to form one or more lower weight molecular compounds selected from the group consisting of methanol, formic acid, acetic acid C-2 alcohols and C-4 alcohols as part of a photocatalyzed mixture, separating said catalyst from said photocatalyzed mixture to form a concentrate, and feeding said concentrate to said microbial fuel cell.

### BRIEF DESCRIPTION OF THE DRAWINGS

Reference may now be had to the following detailed description, taken together with the accompanying drawing, in which:

FIG. 1 illustrates schematically a flow chart showing the photocatalysis of lignin using TiO₂ as a catalysts in the production of fuel cell feedstock, chemicals;

FIG. 2 illustrates graphically a photo reactor used in the process of the present invention;

FIG. 3 illustrate schematically a microbial fuel cell (MFC) established using feedstock chemicals used by the current process;

FIG. 4 illustrates graphically the effect of TiO₂ particle size on chemical oxygen demand (COD) reduction;

FIGS. 5 and 6 illustrate graphically the CO₂ yield as a function of TiO₂ concentration;

FIG. 7 illustrates graphically the effect of aeration on chemical oxygen demand (COD) reduction;

FIG. 8 illustrates graphically final and start pH conditions in photoreactors in relation to TiO₂ concentration;

FIGS. 9a and 9b illustrate graphically the fuel cell voltage generation from glucose at ambient and mesophilic temperatures;

FIG. 10 illustrates graphically polarization and power density curves at ambient and mesophilic temperatures;

FIG. 11 illustrates graphically oxidation-reduction potential of electrodes in glucose;

FIG. 12 illustrates voltage generation from a pretreated lignosulfonate solution;

FIGS. 13 and 14 illustrate power density and polarization curves in pretreated lignin and lignin model compound fed fuel cells; and

FIG. 15 illustrates graphically a cyclic voltammogram of a catalytic bacterial biofilm.

### DETAILED DESCRIPTION OF THE PREFERRED EMBODIMENTS

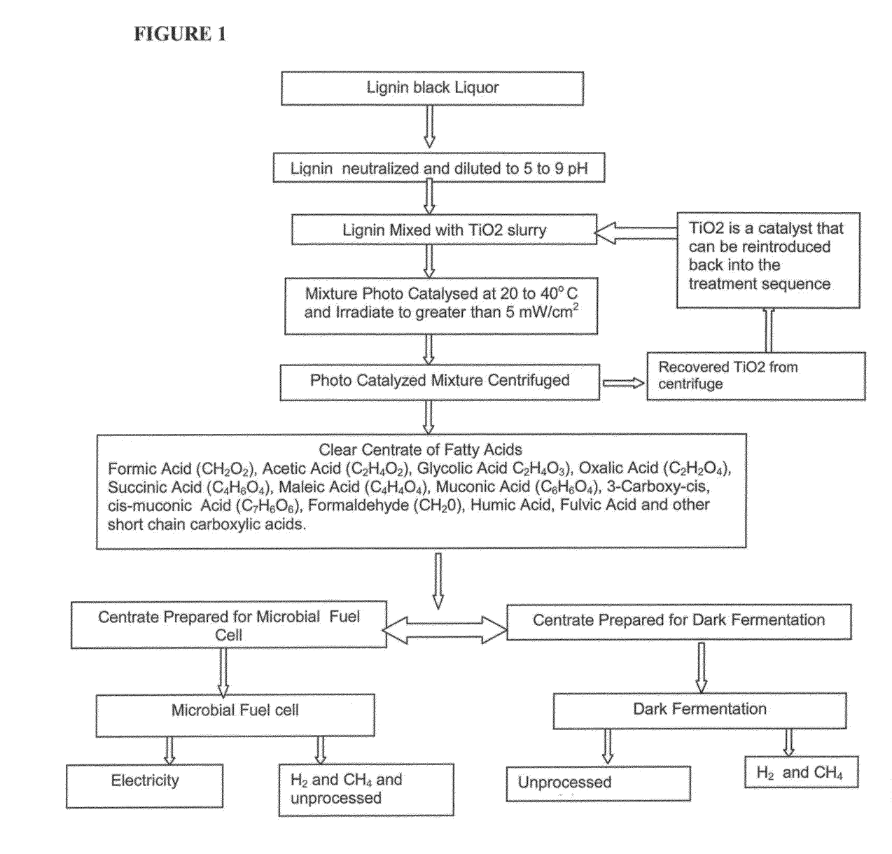

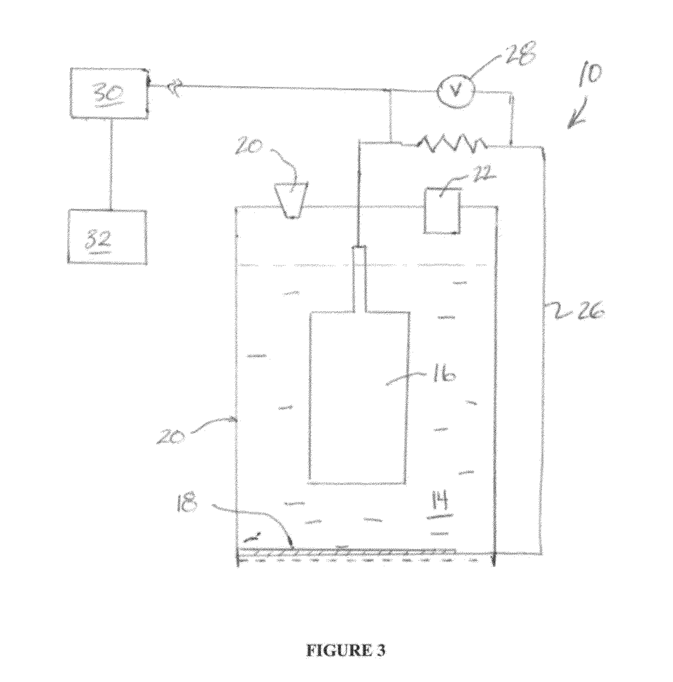

Reference may be had to FIG. 1 which illustrates a process flow chart for the production of feedstock chemicals for use in a microbial fuel cell 10 (MFC) (FIG. 3), and most preferably a single cell microbial fuel cell (SC-MFC) by the photocatalysis of lignin in accordance with a preferred embodiment. In the embodiment shown, the reaction most preferably incorporates TiO₂ as a metal oxide catalyst as facilitating the degradation process, however other catalysts may also be used.

In particular, the applicant has recognized that a heterogeneous photocatalysis reaction of a lignin source material using TiO₂ (Equation 1) in the presence of electromagnetic energy, and preferably UV light, can be achieved in accordance with several steps, namely, 1. Mass transfer of the organic contaminant(s) in the liquid phase to the TiO₂ surface; 2. Adsorption of the organic contaminant(s) onto a photon activated TiO₂ surface (i.e. surface activation by photon energy occurs simultaneously in this step); 3. Photocatalysis of the adsorbed phase on the TiO₂ surface; 4. Desorption of the intermediate(s) from the TiO₂ surface; and 5. Mass transfer of the intermediate(s) from the interface region and into the bulk fluid.

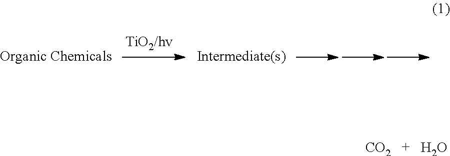

Controlling the photocatalytic process to produce biodegradable intermediates from complex carbon chemicals has previously been reported using model lignin compounds, such as syringol and guaiacol.

The present invention recognizes as advantageously providing feedstock chemical containing degradable intermediates of a lignin source material for use in a variety of commercial and industrial application. Further controlling TiO₂ photocatalytic conditions to produce short chain carbon compounds from lignin source materials which can be utilized to produce energy by anaerobic digestion or microbial fuel cells (MFCs) has also been recognized.

Microbial fuel cells (MFCs) are comparatively recently developed microbial electrochemical technologies that convert reduced carbon containing chemicals to electricity, and possess advantages including: (i) high conversion efficiency is achieved by the conversion of substrate energy to electricity; (ii) efficient operation at ambient and at low temperatures distinguishes them from current bio-energy processes; (iii) gas treatment is not required because the off-gases from MFCs are enriched in carbon dioxide; (iv) energy input is not required for aeration provided the cathode is passively aerated; and (v) potential application in areas lacking electricity infrastructure.

In accordance with a preferred embodiment, the applicant has undertaken preliminary studies towards the viability of a system and apparatus for producing intermediate biodegradable feedstock chemicals from a model lignin compound, and preferably sodium lignosulfonate (LS), using photolysis, and their subsequent use as electricity generating intermediate feedstock chemicals for use in a MFC.

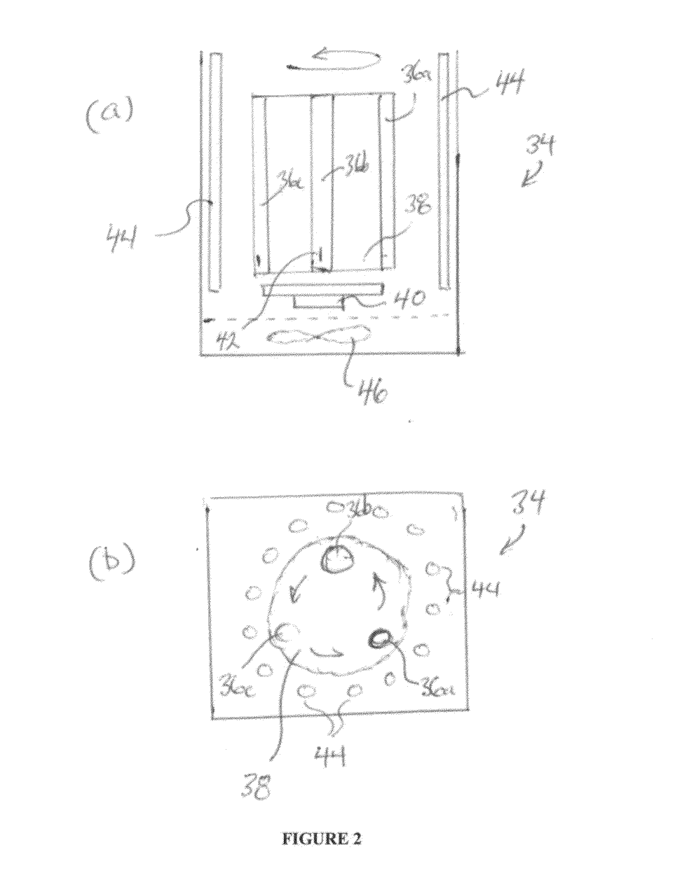

A schematic showing an exemplary process used to produce feedstock chemicals is illustrated in FIG. 1. As will be described, in the preferred method photocatalysis of the lignin model compound was performed in conjunction with the use of TiO₂ as a catalyst and with exposure to electromagnetic radiation in the ultraviolet (UV) wavelength range. Details of the photocatalysis process and a subsequent electricity production process using a prototype single cell micro fuel cell SC-MFC 10 shown in FIGS. 2 and 3 and described below.

### i) Test Feedstock Solution

During a biological oxygen demand (BOD) test, test samples were seeded with raw domestic wastewater obtained from the Lou Romano water reclamation plant in Windsor, Ontario, Canada. Specific test samples were mixed with a lignin compound to provide a LS source mixture. A catalyst, and preferably TiO₂ was added to the mixture to provide a photocatalyzable source slurry

FIG. 2 illustrates a photochemical reactor 34 used in the test irradiation of a feedstock slurry in the validation of the present invention. The reactor 34 is shown in the side view (FIG. 2A) as including transparent reaction tubes 36a,36b,36c which are mounted on a rotary carrousel 38. Optionally, a magnetic stirrer 40 may be positioned beneath the carrousel 38, and which is operable with magnetic stirring bars 42 which are provided in the bottom of each vessel 36.

As shown in the top view of FIG. 2B, and array of ultraviolet lamps 44 are positioned within the reactor 34 extending radially about the carrousel 38. Most preferably, the UV lamps are provided as monochromatic lamps operable to emit UV light energy in the 100 to 400 nm range. Optionally, a cooling fan 46 may be provided to assist in dissipating heat generated by the UV lamp 44 operation, maintaining the interior of the reactor 34 at a desired internal temperature.

As will be discussed, alter initial preparation of the source mixture, the photoactivatable catalyst was added to the mixture to form a source slurry. The mixture/catalyst ratio is selected whereby exposure to UV light effects the photocatalytic degradation of the lignin source material. In prototype testing, the source slurry is introduced into the reaction tubes 36a,36b,36c as reaction vessels, and exposed to UV light energy from the lamps 44, whilst the carrousel 38 was rotated, and the stirrer 40 was simultaneously actuated to effect slurry mixture by way of the stirring bars 42.

Following exposure to the UV light, the photocatalyzed effluent from the photochemical reactor 34 was removed from the reaction tubes 36, and thereafter centrifuged using a Marathon™ 3200R centrifuge, (Fisher-scientific, Blaine, Minn.) at 3000 rpm for 20 minutes to separate the TiO₂ particles from the aqueous solution. The resulting clear concentrate was removed and stored as a purified feedstock for further use, as for example for feeding a microbial fuel cell 10.

In experimental testing, separate comparative solutions A and B were prepared to assess the effectiveness of lignin as a source of biodegradable intermediate constituents in feedstock solution for use in a MFC 10.

Solution A used in the exemplary study contained glucose plus nutrients, and was provided as substantially lignin free. In particular, solution A contained the following: 500 mg L-1 glucose, 310 mg L⁻¹ NH₄Cl, 130 mg L⁻¹ KCl, 4225 mg L⁻¹ NaH₂PO₄.H₂O, 7400 mg L-1 Na₂HPO₄.12H₂O, 10 mg L⁻¹ yeast extract and 1 mL L⁻¹ of a mineral solution.

Solution B contained tire photocatalytic intermediates derived from the photocatalysis of sodium lignosulfonate (LS) as a lignin source material, plus nutrients. In particular, solution B contained the resulting degraded effluent from the LS feed photochemical reactor 34 (392 mg COD L⁻¹), as well as all of the other constituents contained in solution A with the exception glucose.

The mineral solution used in solutions A and B was prepared in accordance with the procedure described by Wiegant, W. M.; Lettinga, G. (1985) Thermophilic anaerobic digestion of sugars in upflow anaerobic sludge blanket reactors. Biotechnol. Bioeng., 27 (11), 1603-1607 and contained the following (Spectrum Chemicals, Calif.); (mg per L of distilled water): NaHCO₃, 6000; NH₄HCO₃, 70; KCl, 25; K₂HPO₄, 14; (NH₄)₂SO₄, 10; yeast extract, 10; MgCl₂ 4H₂O, 9; FeCl₂ 4H₂O, 2; resazurin, 1; EDTA, 1; MnCl₂ 4H₂O, 0.5; CoCl₂ 6H₂O, 0.15; Na₂SeO₃, 0.1; (NH₄)₆MoO₇.4H₂O, 0.09; ZnCl₂, 0.05; H₃BO₃, 0.05; NiCl₂.6H₂O, 0.05; and CuCl₂.2H₂O, 0.03. All nutrient chemicals were 99% purity (St. Louis, Mo.).

### ii) Photocatalysis of LS Test Solutions

Photocatalysis was conducted using sodium lignosulfonate (LS) (Sigma-Aldrich 99% purity (St Louis, Mo.) added to the test solution as the lignin source. A stock suspension of TiO₂ nanoparticles in an aqueous mixture was prepared for use as a catalyst, and stored at 21° C. in sealed 20 ml vials. The stock solutions of TiO₂ were sonicated in an ultrasonic bath (VWR, Mississauga, ON) for approximately 10 to 15 minutes to ensure homogeneous mixing prior to reaction solution preparation.

Three different TiO₂ anatase nanoparticles sizes (5 nm, 10 nm and 32 nm) (Alfa Aesar, Ward Hill, Mass.) were used in experimental studies. The size of nanoparticle catalyst selected was based on optimum COD removal with the characteristics for the three different TiO₂ nanoparticles are shown in Table 1.

TABLE 1
TiO₂ catalyst surface area (Choquette-Labbé et al. (2014)).

| Particle Size (nm) | Surface Area (m² g⁻¹) |
|---|---|
| 5¹ | 275 ± 15² |
| 10¹ | 131 ± 12² |
| 32¹ | 47 ± 2² |

¹Particle size as per manufacturer specifications (Alfa Aesar, Ward Hill, MA)
²Surface area (m² g⁻¹) of the TiO₂ nanoparticles were determined using a Brunauer-Emmett-Teller (BET) gas adsorption technique in a Quantachrome NOVA 1200e surface area analyzer (Quantachrome Instruments, Boynton Beach, FL. The instrument temperature was set at 77 K and nitrogen (BOC, Windsor, ON) was the adsorbate.

Photocatalytic reactions were performed in a modified Rayonet RPR-100 UV photocatalytic reactor 34 (The Southern New England Ultraviolet Company, Conn.), having the configuration described above shown generally in FIG. 2.

The photo-reactor 34 was configured with the array 16 RPR-3000 photochemical UV lamps 44 (Southern New England Ultraviolet Co., Branford, Conn.), operable to emit 300 nm UV light. UV irradiance in the range of about 7 to 12, and preferable, about 9 mW cm⁻² was measured using a UVX Radiometer (UV Process Supply, Chicago, Ill.). The UV lamps 44 were turned on 1 hr before initiating experiments to obtain a stable light intensity. The reaction tubes 36a36b,36c were placed on the carrousel 38 and rotated at a fixed rpm during exposure to the UV radiation.

The reaction tubes 36a,36b,36c were formed as vials dimensioned 25 mm inner diameter×250 mm and were constructed from Pyrex® and fused quartz tubing (UV transmitting clear fused quartz (GE 214, Technical Glass Products Inc., Painesville Twp., Ohio)). The Pyrex® upper portion of each vessel 36 was connected to the fused quartz bottom using a graded seal (Technical Glass Products, Inc., Painesville Twp., Ohio). The reaction tubes 36a36b,36c were wrapped in aluminium foil before placing them in the reactor 36 to prevent initiation of the reaction from extraneous light sources.

The total liquid volume of test source slurry was maintained at 50 mL in each reaction tube 36. The test source slurry consisted of TiO₂ slurry and LS. All solutions were prepared in Milli-Q® water. The test slurry mixture was purged for 2 minutes with oxygen (BOC Gases Division ltd, Windsor, ON). After purging, the reaction vessels 36 were each sealed immediately with Teflon® septa and aluminium crimp cap, prior to UV light exposure.

Over the duration of UV exposure reaction, the reaction tubes 36 were positioned into slots placed on the carrousel 34, and rotated at 10 rpm. All experiments were conducted in triplicate. Chemical oxygen demand (COD) and biological oxygen demand (BOD) of the test liquid samples were determined in accordance with Standard Method (APHA, 2005). The levels of CO₂, H₂, and CH₄ in gas samples from the photocatalytic reactor 34 and MFCs were determined using a Varian-3600 (Palo Alto, Calif.) gas chromatograph (GC) configured with a TCD detector. A 2 m long×2 mm I.D. Carbon Shin column (Alltech, Deerfield, Ill.) was used to conduct the gas analysis. The GC injector, detector, and oven temperatures were set at 100° C., 200° C., and 200° C., respectively. The carrier gas used was N₂ at a flow rate of 15 mL min⁻¹.

Following photocatalytic degradation, it is recognized that the catalyst may be separated from the photocatalyzed lignin by various possible methods. For example, separation may be effected by way of centrifuge, filtration, or by columnar separation to obtain a catalyzed concentrate. The resulting concentrate may thus be used in a number of different industrial and/or commercial processes. Exemplary uses would include for use in the microbial fuel cell 10 or as a source material for the generation of methane and/or hydrogen.

iii) Exemplary Use—Inocula for Microbial Fuel Cells

FIG. 3 illustrates schematically a single chamber microbial fuel cell 10 in accordance with a preferred aspect of the invention. The fuel cell 10 includes a reactor chamber 12 which may for example be provided in the form of an acrylic or plastic cylindrical tank. The chamber 12 is sized to receive a volume of feedstock concentrate prepared in accordance with the current invention. The microbial fuel cell 10 preferably is provided with the reactor chamber 12 having a working volume of 100 L to 150 L, and preferably about 130 L. A graphic plate anode 16 and air cathode 18 are provided within the reactor chamber 12. The anode 16 used was selected as a carbon brush electrode (Mill-Rose Co., Mentor, Ohio). Prototype carbon brush electrodes 9 cm long and 9 cm in outer diameter consist of a Panex™ 35 carbon fiber fill (400,000 tips per inch) fixed to a Titanium stem wire which was 12.5 cm long and 0.135 cm in diameter. In addition, a sampling port 20 and gas outlet 22 provide fluid communication with the chamber interior 12 for introducing fresh concentrate and venting reaction gases therefrom.

Conductive copper wiring 26 provides electrical connections between the anode 16 and cathode 18, as well as preferably a volt meter 28 which electronically communicates with a data acquisition unit 30 and processing device 32 such as a desk top computer, central processing unit, laptop or the like. Optionally, the fuel cell 10 may be provided with a perforated acrylic reactor support 24 for enhanced stability.

The single chamber MFC 10 (SC-MFC) was first inoculated with cultures from two chamber MFCs (not shown), and which were previously used for other studies. The two chamber MFCs were inoculated with a mixed anaerobic culture which was obtained from a municipal wastewater treatment facility in Chatham, Ontario.

In test studies, the SC-MFC 10 was operated in batch mode, with the SC-MFC 10 fed repeatedly with fresh volumes of solution A or solution B, when voltage was measured as decreasing to less than 20±5 mV, and with the time to decrease to below 20±5 mV designated in the data acquisition unit as one feeding cycle.

Cell voltages (V) of the MFC 10 sampled every 5 min using an Agilent 34970A data acquisition unit 30 connected to the processing device 32. A full channel scan was performed for all MFCs and the data was stored for analysis. The potential of the anode and cathode electrodes 16,18 was measured versus an Ag/AgCl reference electrode (Part no. CHI111) (CH instruments Inc., Austin, Tex.), with the anode 16 or the cathode 18 as the working electrode. This was conducted by varying the circuit load (external resistance). The different external resistances used were 1,000,000, 10,000, 5,600. 1,000, 680, 470, 330, 220, 100, 47, 8.2 and 1.5Ω, with each resistance connected to the circuit for 15 min. The potential (V) was used to calculate the current (I).

Cyclic voltammetry (CV) was performed using a computer-controlled potentiostat (CH Instruments, CHI684, Austin, Tex.) in a three electrode cell consisting of an anode as the working electrode with a counter platinum electrode and an Ag/AgCl reference electrode. The polarization and power density curves for SC-MFC 10 was obtained using linear swipe voltammetry (LSV). The coulombic efficiencies (CE) for the SC-MFC 10 fed with solution A and solution B were calculated using equations 1 and 2 respectively.

$${C}_{E} = \frac{{M}_{x} {\int }_{0}^{{t}_{b}} I d t}{{Fb}_{es} {v}_{A π} Δ c} \qquad ( 1 )$$

wherein M_{b} is the molecular weight of the substrate, tb is time for one feeding cycle, F is Faraday's constant, bₑₛ is number of moles of electrons per mole of substrate, ν_{An} is the volume of liquid in the anode compartment and Δc is the substrate concentration change over a feeding cycle.

$${C}_{E} = \frac{M {\int }_{0}^{{t}_{b}} I d t}{{Fbv}_{A π} Δ COD} \qquad ( 2 )$$

where M is the molecular weight of oxygen, b is the number of electrons exchanged per mole of oxygen and ΔCOD is the change in the chemical oxygen demand (COD) over a feeding cycle.

### iv) Photocatalytic Degradation—Irradiation Time

Preliminary studies using LS photocatalytic degradation byproducts were performed to assess the optimum UV irradiation time required to effect photocatalytic degradation of lignin components. It has to be found that the irradiation time profile for the degradation of LS (at concentrations of 500 mg L⁻¹) at different TiO₂ concentrations indicated an increase in CO₂ production and COD removal efficiency with increase in irradiation time. Longer irradiation time resulted in the conversion of LS and intermediate chemicals to CO₂ and H₂O. Long irradiation time will result in higher energy consumption and higher retention time. With complete mineralization, however, the BOD available for electricity production would be eliminated.

It is recognized that it is possible to control lignin degradation, and preferably sodium lignosulfonate (LS) degradation to biodegradable intermediates which themselves show promise for use in secondary industrial and commercial applications, such as for example as feedstocks for microbial fuel cells and/or for use in the fermentation process for H₂ and/or CH₂ production. Experimental results suggest that an optimum illumination time to achieve maximum production of intermediates by the photocatalysis of lignin slurries is in the range of 1 to 6 hours and preferably about 4 hours ±0.5. Therefore, unless otherwise stated, all subsequent photocatalytic degradation experiments were carried out with a 4-hr irradiation time.

### v) Effect of Catalyst Particle Size

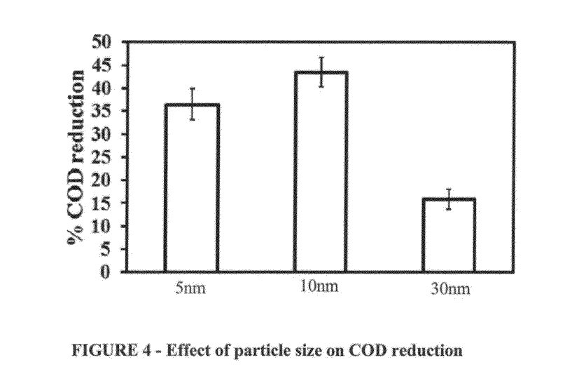

In experimental studies, a sample source solution comprising LS in an initial concentration of 500 mg L⁻¹ (683 mg COD L⁻¹) was selected to assess the effects of catalyst particle size and its affect on the photocatalytic process. Of the three TiO₂ particle size selected identified in Table 1 above, the greatest COD removal was observed at 10 nm (FIG. 4). At an effective particle size less than 30 nm, the apparent photoactivity increases sharply with particle size, and the apparent photoactivity decreases with increasing particle size greater than 30 nm. According to work reported Choquette-Labbé, M.; Shewa, W. A.; Lalman, J. A.; Shanmugam, S. R. (2014) Photocatalytic degradation of phenol and phenol derivatives using a nano-TiO₂ catalyst: Integrating quantitative and qualitative factors using response surface methodology, Water, 6 (6), 1785-1806, for the photocatalytic degradation of phenol and phenol derivatives using 5, 10 and 32 nm TiO₂ the predicted optimum particle size was 11 nm. FIG. 4 shows graphically the percentage of COD reduction achieved by photocatalytic reaction when comparing the effect of 5 nm and 10 nm TiO₂ particles on LS degradation.

### vi) Catalyst Loading/Concentration

It has further been anticipated that different optimum catalyst loadings exist for different types of different catalyst chemicals, depending on the specific lignin concentration. The reasons for variations in the optimum catalyst concentration values are understood to be due to a number of factors including variation in the reactant type and concentration, aeration, irradiation time, reactor size and geometry/design, irradiation wavelength and intensity of the light source and operating conditions of the photoreactor such as temperature, pH, rpm.

The effect of catalyst loading on LS degradation was examined by varying the TiO₂ concentration from 0.5 g L⁻¹ to 3.5 g L⁻¹, with a view to assessing whether operating at an optimum catalyst loading could be selected to ensure efficient photon absorption, and avoid the use of excess catalyst.

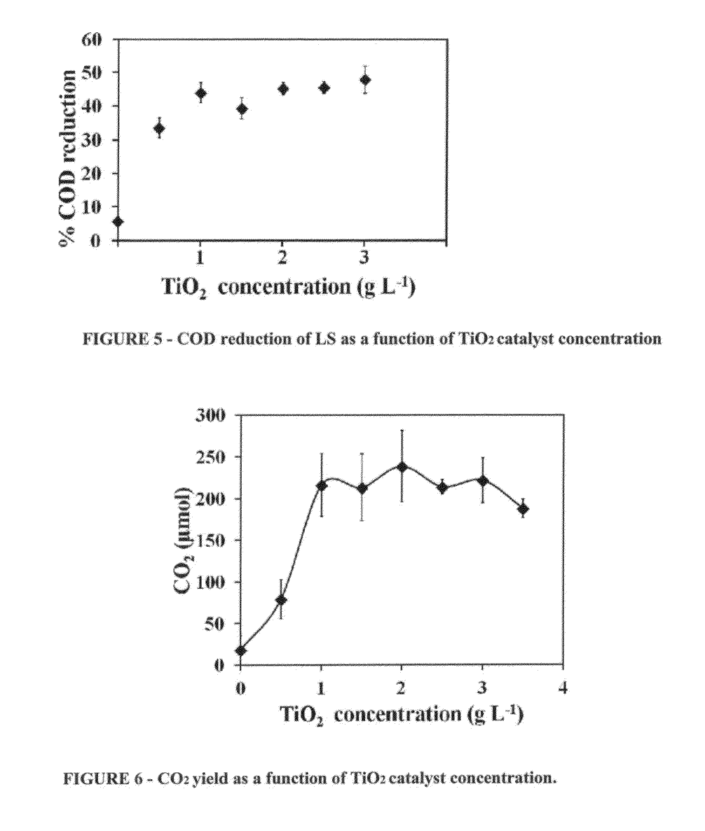

The COD removal efficiency data depicted in FIG. 5 indicates that the highest COD removal efficiency was observed at the catalyst dose of 1 g L⁻¹. The COD removal efficiency was shown as increasing with initially increased TiO₂ catalyst concentration, up to a concentration of 1 g L⁻¹. At greater levels, the catalyst efficiency remained more constant. Therefore, an optimum TiO₂ catalyst concentration of 1 g L⁻¹ was selected to effectively degrade LS at a 4-hr irradiation time and at 10 rpm. As shown in FIG. 6, CO₂ yield was likewise observed increased sharply as the TiO₂ catalyst concentration increased to 1 g L⁻¹, with CO₂ concentrations, like the % COD remaining relatively constant at concentrations thereabove.

Experimental results suggest that beyond a threshold level, increasing catalyst concentration, while maintaining operability of the invention, will not necessarily result in a corresponding increase in COD reduction. This may be attributed to a number of possible factors. Without being bound by a particular theory, the clustering of catalyst particles at higher concentrations may lead to less surface area and hence, less catalytic sites. Third parties have also reported that increasing the catalyst loading beyond an optimum level result in non-uniform light intensity distribution and hence, lower reaction rates.

vii) Air Purging

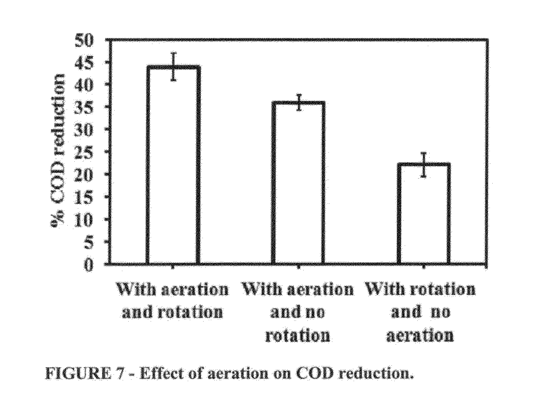

The dissolved oxygen in the reaction mixture was also shown to have had a significant effect on the degradation process. Oxygen addition directly into a reactor is believed to result in appreciable increase in the photocatalytic degradation rate. During LS photo-degradation with and without purging with air, the % COD removed of were 43.9±3.0 and 22.2±2.5, respectively (FIG. 7). Similar studies by on the photocatalytic degradation of textile wastewater with and without air sparging reported % COD reduction values of 40% and 23%, respectively.

viii) UV Illumination

The batch reactor 34 used in the present study including a carrousel 38 used to rotate the reaction vessels 36 at about 10 rpm to attain uniform UV exposure and illumination. Photocatalytic degradation of slurry samples was examined with and without rotation. The results indicate a final COD of 392.6±2 mg L⁻¹ and 448.0±11 mg ⁻¹with and without rotation, respectively, at an initial pH of 8.0, an initial COD of 683 mg COD L⁻¹, 1.0 g L⁻¹ TiO₂ and a 4-hr reaction time. As a result, a 7.9 % decrease in COD removal efficiency was observed as a result of operating the reactors with and without rotation.

The low biological oxygen demand (BOD) of LS before photocatalysis is believed indicative that it was recalcitrant to the inocula (Table 2). Alter photocatalysis, under conditions of 4-hr UV irradiation, an initial pH of 8.0, with carrousel rotation of 10 rpm, a TiO₂ particle size and concentration of 10 nm and 1 g L⁻¹ respectively, the amount of BOD5 (Table 2) observed is attributed to the biodegradable organic compounds formed during the photocatalytic degradation of LS. Without being bound by a particular theory, its understood that photocatalysis is degrades LS to form lower molecular compounds such as methanol, formic acid, acetic acid, and small amounts of C-2 and C-3 alcohols by the photocatalytic oxidation of lignin; and/or short chain fatty acids produced from the photocatalysis of a model lignin compound. In particular, third party studies have shown the conversion of bioresistant and toxic acid orange 7 compounds to more readily biodegradable byproducts using TiO₂-mediated photocatalysis.

TABLE 2
BOD, COD and gas production data.

| Initial concentration | | Concentration after | | Gas production | |
|---|---|---|---|---|---|
| (mg L⁻¹) | | photocatalysis (mg L⁻¹) | | (mL g⁻¹ COD) | |
| COD | BOD₅ | COD | BOD₅ | H₂ | CH₄ |
| 683 | 0 | 393 | 148 | 0.44 | 121.04 |

Note 1:
BOD₅ = 5-day BOD

The BOD5 of pretreated LS (COD=392.6±2 mg L⁻¹) was determined as 147.6±9 mg L⁻¹. Using this data, the BOD5/COD ratio is approximately 0.38.

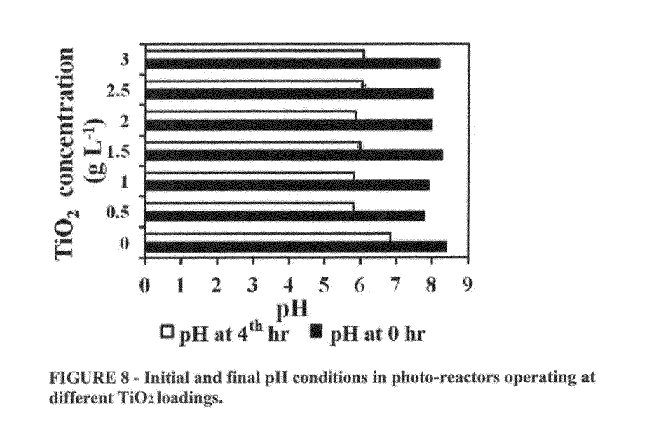

The initial pH of the reaction mixture and the final pH of the effluent from the photocatalytic reactor were compared. A reduction in pH values was observed with increased UV exposure (FIG. 8). In all cases, the pH decreased was likely attributed to the formation of volatile fatty acids and CO₂ during LS photo-degradation. A maximum change in pH of approximately 2.1 was observed in reactors fed 1 g L⁻¹ TiO₂ after 4 hour of irradiation.

In one exemplary application, dark fermentation of die photocatalysis byproducts was conducted under batch conditions for 4 days at 37±1° C. The gas production yield from dark fermentation was 174 mL CH₄ per g COD_{added}, as contrasted with a theoretical amount of CH₄ produced from glucose is 350 mL CH₄ per g COD_{added}. In the fermentation study, with 4 hours of batch fermentation, approximately 50% of the theoretical methane production was attained.

### ix) Comparative Examples—Single Cell Microbial Fuel Cells

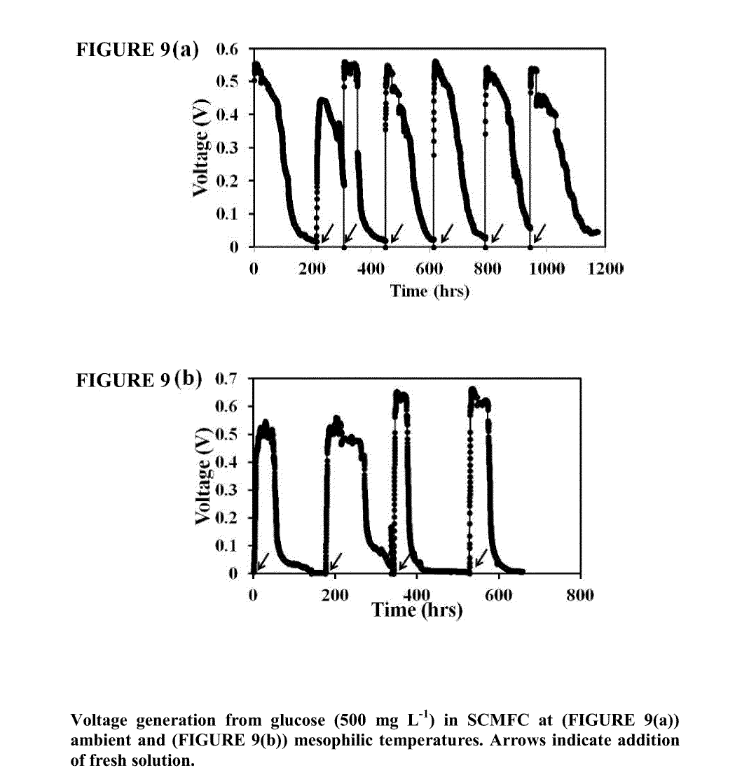

Comparisons of the single cell microbial fuel cells were undertaken using Solution A which contained glucose. The single cell MFC 10 was started up and operated at 21±1° C. for 7 cycles (FIG. 9(a)) and then operated at a mesophilic temperature of 37±1° C. for 4 cycles (FIG. 9(b)). Temperature is an important factor affecting treatment efficiency and power generation. The performance of the MFC 10 was shown higher under high temperature conditions when compared to lower temperature conditions.

The SC-MFC 10 produced repeatable and stable voltages in all the feeding cycles at 21±1° C. and 37±1° C. The maximum voltage obtained at 21° C. was 536±40 mV. In comparison, the maximum voltage for the SC-MFC 10 operating at 37° C. reached 658±8 mV. Without being bound by a particular theory, the observed voltage increase may be due to increase in the population and acclimatization of electrogenic microbes to the mesophilic temperature condition. Increasing the temperature from 21° C. to 37±1° C. caused an increase in voltage of approximately 23%.

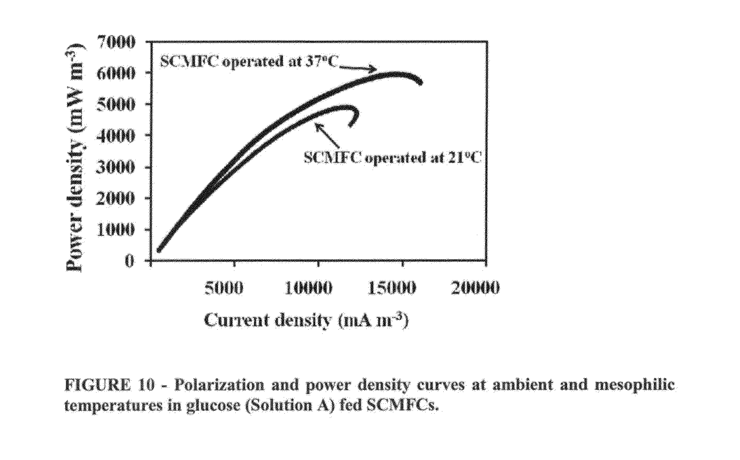

The maximum current and power densities were determined using linear sweep voltammetry (LSV) (see for example FIG. 10). The LSV study was conducted by varying the potential of the working electrode at a scan rate of 1 mV s⁻¹. The data show that at 21±1° C., maximum current and power densities were 1614 mA m⁻² and 691 mW m⁻³, respectively. At 37±1° C. the maximum current and power densities increased to 2266 mA m⁻² and 851 mW m⁻³, respectively (Table 3). The temperature increase from 21±1° C. to 37±1° C. resulted in a 40% and 23% increase in the current and power densities, respectively. In earlier studies, operating at 15° C. and at 30° C. verified that higher temperatures increased the bacterial activity, which in return enhanced the power output and reduced the internal resistance.

TABLE 3
Maximum current and power density of SCMFCs operated at ambient
and mesophilic temperatures in glucose (Solution A) fed SCMFCs.

| | | | | | Internal |
|---|---|---|---|---|---|
| Temp | Current density | | Power density | | Resistance |
| (° C.) | mA m⁻³ | mA m⁻² | mW m⁻³ | mW m⁻² | ohms |
| 21 ± 1 | 11317 ± 865 | 1614 ± 123 | 4843 ± 371 | 691 ± 53 | 271 ± 22 |
| 37 ± 1 | 15887 ± 1942 | 2266 ± 277 | 5971 ± 7 | 851 ± 1 | 173 ± 42 |

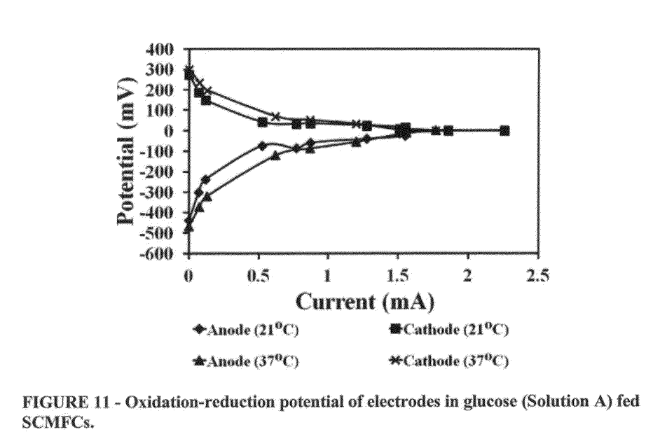

Electrode potentials were measured at temperatures of from about 21±1° C. to 37±1° C., as shown In FIG. 11, by varying the circuit load as described above. The observed data indicates that the oxidation-reduction potential of the single cell microbial fuel cells 10 increased when the operating temperature was increased from 21±1° C. to 37±1° C.

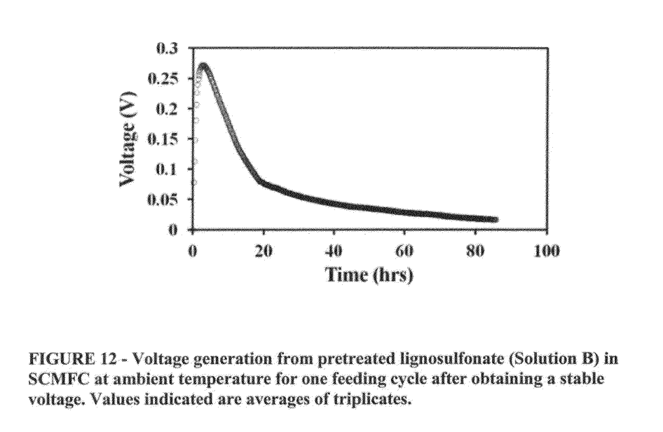

FIG. 12 illustrates voltage generation using Solution B containing photocatalytic intermediates produced by the photocatalysis of lignin compounds. In experimental studies, maximum voltage produced from the pretreated LS source solution in one feeding cycle was 272±8 mV. A typical voltage generation pattern for one feeding cycle is shown in FIG. 12, wherein the voltages increased to a maximum within 3 hours, and gradually decreased to 20 mV after approximately 80 hr as the substrate was depleted. Without being bound to a particular theory the rapid voltage increase is believed attributed to the presence of electrochemically active biofilms attached to the anode, rather than the microbes in the medium. Similar observations were reported when performing experiments using MFCs inoculated with sludge containing mixed cultures.

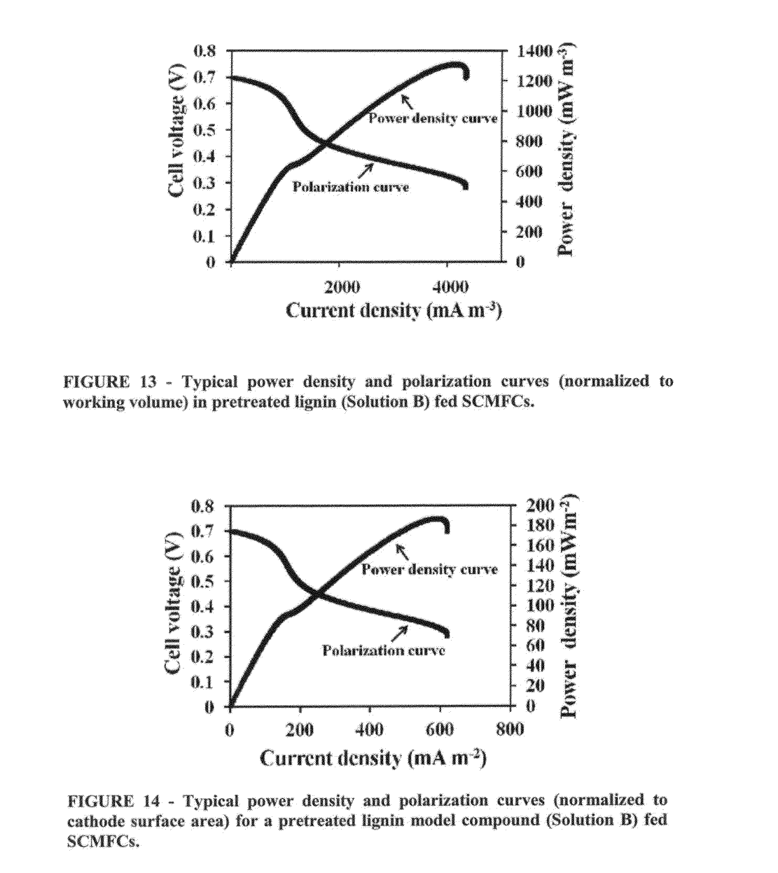

The single cell microbial fuel cells 10 fed with a feedstock of Solution B generated maximum current and power densities of 3925±280 mA m-3 and 1164±208 mW m⁻³, respectively (FIG. 13), with corresponding maximum current and power densities normalized to cathode area are 560±40 mA m⁻² and 166±30 mW m⁻², respectively (FIG. 14).

In the exemplary study, cyclic voltammetry (CV) was employed to acquire qualitative data related to electrochemical reactions and to locate redox potentials of the electroactive species of the SC-MFCs. The potential scan from −0.5 V to +0.5 V was performed at a scan rate of 1 mV s.

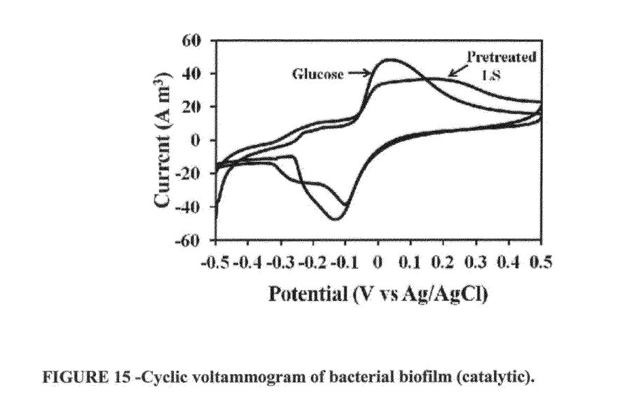

Multiple peaks in the cyclic voltammograms of bioelectrochemical system may be observed due to multi-step parallel or consecutive (series) mechanisms or to the presence of several different redox species. The multiple redox peaks (FIG. 15) in the cyclic voltammograms in the SC-MFCs fed with glucose (Solution A) indicate the presence of several redox species. Peaks observed for SC-MFCs fed with preheated LS (Solution B) indicate the presence of electrogenic bacteria attached to the brush electrode (FIG. 11). The data suggest electrogenic microorganisms such as Geobacter sulfurreducens, Shewanella oneidensis MR-1, Rhodoferax ferrireducens, Aeromonas hydrophila, Hansenula anomala could be involved in the electron transfer process.

The pretreatment photocatalysis reaction thus converted LS into biologically degradable organic compounds and at the same time reduced the COD from 683 mg L⁻¹ to 393 mg L⁻¹ (43% COD removal efficiency). The SC-MFC further reduced the COD from 393 mg L⁻¹ to 94 mg L⁻¹(76% COD removal efficiency). The two processes were able to remove approximately 86% of the COD due to LS. As such, data indicates that integrating photocatalysis with an MFC 20 with serve as a potential option for COD removal from lignin-rich wastewaters. Earlier studies conducted for single chamber microbial fuel cells fed with a complex steroidal drug industrial effluent reported a COD removal efficiency of 84%.

### x) Coulombic Efficiency

It is difficult to compare coulombic efficiencies (CEs) reported by different researchers due to differences in substrate type, concentrations used and the microbial fuel cell configurations, earlier studies have reported CEs range from 14-20% for glucose and values of up to 8% for wastewaters. The coulombic efficiency in the present study at 21±1° C. was found to be 4.7±0.4%. Studies have reported a lower coulombic efficiency of 4% for Shewanella putrefaciens culture fed lactate and a microbial fuel cell configured with a Mn(IV)graphite anode and an air-cathode; and investigated the performance of an MFC exposed to low operating temperature while treating a synthetic wastewater also found a CE of 5%. Other similar studies also repotted a CE of 2.79±0.6% using cattle manure us a substrate.

Without being bound by a particular theory, the lower CE value in the present study is believed due to the conversion of the consumption of the substrate by non-electrogenic bacteria. The possible electron sinks in the single cell microbial fuel cells 20 could be attributed to biomass formation as well as the formation of soluble organic products, H₂ and CH₄. Diffusion of oxygen into the SC-MFC chamber may also result in aerobic degradation of the substrates leading to a decrease in CE. In laboratory studies at 37±1° C., a coulombic efficiency of 17.2±1.1% was obtained using pretreated LS (COD=392.6±2 mg L⁻¹).

The pretreatment of LS using TiO₂ photocatalysis under UV illumination of 4 hr thus suggest an optimum TiO₂ size and loading were 10 nm and 1 g L⁻¹, respectively. The. SC-MFCs which used photocatalyzed LS carbon byproducts and operated at ambient temperature generated a maximum current and power densities of 3925±280 mA m⁻³ and 1164±208 mW m⁻³, respectively. The corresponding maximum current and power densities normalized to cathode area were 166±30 mA m⁻² and 560±40 mW m⁻², respectively. Photocatalysis together with bio-electrochemical degradation removed 86% of the LS COD.

### xi) Exemplary Process

As a result, combined photocatalysis together with bio-electrochemical degradation can be useful for generating electricity from a model lignin chemical. The process and method described herein has a variety of uses, including in the pulp and paper industries, sugar cane milling industries, landfill leachate treatment operators and any other facilities generating waste containing lignin.

On the basis of preliminary exemplary studies, the applicant has envisioned an improved process for the generation of electricity using a microbial fuel cell, as well as a process for providing such fuel cells with feedstock chemicals which are formed from the photocatalysis of lignin.

In one simplified process, a volume of lignin black liquor is chosen as a source material.

In the process, lignin is neutralized and diluted to a pH of 5 to 9.

Following dilution, the neutralized lignin is mixed with a metal oxide and/or metal sulphide catalyst, and preferably TiO₂, which is provided to form a chemical feedstock slurry.

The mixture is then photocatalyzed at temperatures of between about 20 and 40° C. while exposed to electromagnetic radiation effected at greater than 5 mW/cm². Most preferably, irradiation is effected by exposure electromagnetic radiation in the ultraviolet light range of 100 to 400 nm, and preferably about 300 nm for up to eight hours, and preferably about 4 hours ±0.5.

Once photocatalyzed, the mixture is then centrifuged to remove TiO₂, and form a clear fatty acid concentrate. The removed TiO₂ may be recovered from the centrifuge and then reintroduced back into a next volume of the lignin mixture, as part of a catalytic slurry. In the typical case, the resulting clear concentrate will include various fatty acids. These may include one or more formic acid, acetic acid, glycolic acid, oxalic acid, succinic acid, maleic acid, muconic acid, 3-carboxy-cis, cis-muconic acid, formaldehyde, humic acid, fulvic acid, as well as short chain carboxylic acids.

The concentrate may then be used in a variety of different commercial and/or industrial applications. Preferably, the concentrate may be prepared for introduction into a microbial fuel cell 10 of the general construction shown in FIG. 3 for the generation of electric current. In such an embodiment, the concentrate may be provided as a batch, or more preferably part of a continuous feed process into the microbial fuel cell reservoir 14. In such applications, with the generated electricity, the bio-chemical process results in the output of H₂ and CH₄, as well as additional unprocessed materials as resulting by-products.

In an alternate non-limiting application, the centrifuged concentrate may be used as part of a bio-hydrogen production system, for generating H₂ and CH₄ for industrial or commercial applications. In such a system, following catalyst removal the concentrate may be subject to a dark fermentation process, producing H₂ and CH₄, as well as unprocessed and/or waste material by-products.

Although the detailed description describes and illustrates various preferred and exemplary embodiments, the invention is not so limited. Many modification and variations will now occur to persons skilled in the art. For a definition of the Invention, reference may be had to the appended claims.

We claim:

1. A method of preparing feedstock chemical for use in a microbial fuel cell, comprising,
admixing a source mixture composing a lignin source material with a catalyst to form a chemical source slurry,
irradiating said source slurry with electromagnetic energy at a wavelength selected to effect photocatalytic degradation of said lignin source material to short chain fatty acid and/or carbon chemicals as part of a photocatalyzed mixture,
separating said metal oxide from said photocatalyzed mixture, and
separating from one or more residual fatty acids from the catalyzed mixture to form a concentrate, and
feeding said concentrate to said microbial fuel cell.

2. The method as claimed in claim 1, wherein the fuel cell comprises a single chamber air-cathode microbial fuel cell, wherein said concentrate is fed into said microbial fuel cell in a substantially continuous feed process, and operating said fuel cell to bioelectrically convert said concentrate into electricity whilst maintaining said concentrate at a temperature selected at between about 35° C. and 40° C.

3. The method as claimed in claim 2, wherein said metal oxide catalyst comprises TiO₂ having an average particle size selected at from 5 nm to less than about 300 nm, and the step of separating said metal oxide comprises physically removing said metal oxide catalyst from said photocatalyzed mixture by centrifuge.

4. The method as claimed in claim 1, wherein said electromagnetic radiation is selected at between about 1 mW/cm² and 100 m/Wcm², and preferably 5 mW/cm².

5. The method as claimed in claim 4, wherein said wavelength is selected in the 100 to 400 nm range, and preferably about 300 nm.

6. The method as claimed in claim 5, wherein the lignin source mixture comprises a sodium lignosulfonate slurry comprising sodium lignosulfonate in a concentration selected at from about 200 mg/L to about 1000 mg/L.

7. The method as claimed in claim 6, wherein said sodium lignosulfate is present in said slurry in an amount from about 400 mg/L to 600 mg/L.

8. The method as claimed in claim 7, wherein the catalyst comprises a solid selected from the group consisting of TiO₂, ZnO₂, CeO₂, CdS and ZS.

9. The method as claimed in claim 7, wherein the catalyst comprises titanium oxide having an average particle size selected at from about 5 nm to less than 30 nm, and preferably about 10 nm.

10. The method as claimed in claim 8, wherein said titanium oxide is provided in said slurry in a concentration of about 0.5 g/L to 2 g/L.

11. The method as claimed in claim 9, further wherein during said step of irradiating said source slurry, purging said mixture with air or oxygen.

12. A method of preparing feedstock chemical for use in a microbial fuel cell, comprising,
admixing a source mixture comprising sodium lignosulfate as a lignin source material with a metal oxide and/or metal sulphide catalyst to form a chemical source slurry,
irradiating said source slurry with electromagnetic energy at a wavelength selected at between about 100 nm and 400 nm for a period of time selected to effect photocatalytic degradation of said lignin source material to form one or more lower weight molecular compounds selected from the group consisting of methanol, formic acid, acetic acid C-2 alcohols and C-4 alcohols as part of a photocatalyzed mixture,
separating said catalyst from said photocatalyzed mixture to form a concentrate, and
feeding said concentrate to said microbial fuel cell.

13. The method as claimed in claim 12, further wherein during said step of irradiating said source slurry, purging said mixture with air or oxygen.

14. The method as claimed in claim 13, wherein the catalyst comprises titanium oxide having an average particle size selected at from about 5 nm to less than 30 nm, and preferably about 10 nm.

15. The method as claimed in claim 14, wherein titanium oxide is provided in said source slurry in a concentration of about 1 g/L.

16. The method as claimed in claim 12, wherein said electromagnetic energy is provided at an intensity selected at between about 1 mW/cm² and 100 m/Wcm², and preferably 5 mW/cm².

17. The method as claimed in claim 16, wherein said wavelength is selected at about 300 nm.

18. The method as claimed in claim 12, wherein prior to said step of irradiation said sodium lignosulfate is present in said source slurry in an amount from about 400 to 600 mg/L.

19. The method as claimed in claim 12, wherein the fuel cell comprises a single chamber air-cathode microbial fuel cell, said concentrate being fed into said fuel cell in a substantially continuous feed process.

20. The method as claimed in claim 18, wherein said step of irradiating said source slurry comprises irradiating said slurry with said electromagnetic radiation for a period of between about 2 and 6 hours, and preferably about 4 hours.

21. A method of preparing a feedstock chemical comprising,
preparing a mixture comprising a lignin source material in a concentration selected at between about 200 mg/L and 1000 mg/L,
adding a photo-activatable catalyst to the source solution to form a chemical slurry, said catalyst composing a solid selected from the group consisting of TiO₂, ZnO, ZrO₂, CeO₂, CdS and ZS,
irradiating said slurry with ultraviolet radiation at a wavelength selected from about 100 nm to about 400 nm to effect at least partial photocatalytic degradation of said lignin source material to one or more residual fatty acid components as part of a photocatalyzed mixture,
separating said catalyst from said photocatalyzed mixture to form a mixture concentrate.

22. The method as claimed in claim 21 further comprising separating one or more of said residual fatty acid components from the mixture concentrate.

23. The method as claimed in claim 21, wherein said feedstock chemical comprises a dark fermentation feed stock.

24. The method as claimed in claim 21, wherein said feedstock chemical comprises a microbial fuel cell feedstock.

25. The method as claimed in claim 21, wherein said lignin source material comprises sodium lignosulfate, said catalyst comprises TiO₂, and said step of separating said catalyst comprises removing said TiO₂ catalyst from said photocatalyzed mixture by centrifuge.

26. The method as claimed in claim 24, wherein said ultraviolet radiation irradiating said slurry at an intensity from about 5 m/Wcm² to about 15 mW/cm², for between about 2 and 6 hours, and preferably about 4 hours.

27. The method as claimed in claim 26, the lignin source material comprises a sodium lignosulfate in a concentration selected at from about 250 mg/L to about 300 mg/L.

28. The method as claimed in claim 27, wherein said mixture further comprises municipal wastewater.
